(19) United States
(12) Patent Application Publication
(10) Pub. No.: US 2023/0094860 A1
(43) Pub. Date: Mar. 30, 2023

(54) SECURE PROCESSING METHOD, APPARATUS, AND SYSTEM USED BY MERCHANT MANAGEMENT DEVICE

(71) Applicant: KOUBEI (SHANGHAI) INFORMATION TECHNOLOGY CO., LTD., Shanghai (CN)

(72) Inventor: Jianxin WU, Shanghai (CN)

(21) Appl. No.: 17/601,691

(22) PCT Filed: Feb. 27, 2020
(86) PCT No.: PCT/CN2020/076867

§ 371 Date: Apr. 12, 2022

(30) Foreign Application Priority Data
Apr. 11, 2019 (CN) 201910290503X

(51) Int. Cl. H04L 9/40

(52) U.S. Cl. CPC H04L 63/08; H04L 63/126

(57) ABSTRACT

There are provided security processing methods, apparatuses and systems for use of merchant management devices, which relate to the field of information processing technology, and can improve the use security of the merchant management device. A security processing method includes: obtaining a device identifier of the merchant management device by scanning an identification code displayed in the merchant management device, wherein the identification code is generated according to the device identifier before entering a system desktop of the merchant management device; sending a notification request carrying the store information, the login account information, and the device identifier, so that in response to that it is determined that security verification is passed according to the store information and the login account information, the store information is forwarded to the merchant management device corresponding to the device identifier to update a scan code state; receiving a binding confirmation instruction, and sending a binding confirmation request, so that the merchant management device, in response to determining that the store information is successfully bound with device information of the merchant management device, displays the system desktop. The present disclosure is suitable for use security processing of the merchant management device.

### CROSS REFERENCE TO RELATED APPLICATIONS

This application claims priority to Chinese patent application No. 201910290503.X entitled “SECURITY PROCESSING METHODS, APPARATUSES AND SYSTEMS FOR USE OF MERCHANT MANAGEMENT DEVICES”, filed with the Chinese Patent Office on Apr. 11, 2019, the entire contents of which are incorporated herein by reference.

### TECHNICAL FIELD

The present disclosure relates to the field of information processing technology, and in particular, to security processing methods, apparatuses and systems for use of merchant management devices.

### BACKGROUND

In the catering industry, waiters/waitresses use merchant management devices to place orders for customers who came to stores for meals. For example, through a point of sale (POS), the POS device, after an order is placed, sends generated order information to a store cashier system to instruct a store kitchen to make a meal in accordance with the order. At present, turning on a merchant management device is just a simple boot operation, by which, applications in the merchant management device can be used. In this way, anyone can use the merchant management device. However, the inventors found that if the merchant management device is used by someone other than a store owner, there may be certain security risks. For example, other users use the merchant management device to send fake customer orders.

### SUMMARY

In view of this, security processing methods, apparatuses and systems for use of merchant management devices are provided in the present disclosure, and a primary object of the present disclosure is to solve the problem of certain potential security risks in the use of the merchant management devices in current prior art.

According to one aspect of the present disclosure, there is provided a security processing method for use of a merchant management device, which can be applied to a client side. The method includes: obtaining a device identifier of the merchant management device by scanning an identification code displayed in the merchant management device, where the identification code is generated according to the device identifier before entering a system desktop of the merchant management device; acquiring login account information and selected store information that is to be bound; sending a notification request carrying the store information, the login account information, and the device identifier, so that in response to that it is determined that security verification is passed according to the store information and the login account information, the store information is forwarded to the merchant management device corresponding to the device identifier to update a scan code state; and receiving a binding confirmation instruction, and sending a binding confirmation request, so that the merchant management device, in response to determining that the store information is successfully bound with device information of the merchant management device, displays the system desktop.

In some examples, performing the security verification according to the store information and the login account information includes: verifying whether a login user corresponding to the login account information matches a preset blacklisted user; and/or verifying whether the login user is currently in a login state; and/or verifying whether the login user has a store management authority of a store corresponding to the store information; and/or verifying whether the store corresponding to the store information is in a valid state; in response to determining that the login user matches the preset blacklisted user, or the login user is currently offline, or the login user does not have the store management authority, or the store is in an invalid state, determining that the security verification fails; and in response to determining that the login user does not match the preset blacklisted user, and the login user is currently in the login state, and the login user has the store management authority, and the store is in the valid state, determining that the security verification is passed.

In some examples, binding the store information with the device information of the merchant management device includes: signing up for store user information included in the store information by using the device information of the merchant management device; adding, to store expansion information included in the store information, corresponding store has been bound to the merchant management device; and establishing and storing an association relationship between the store information and the device information.

In some examples, before receiving the binding confirmation instruction, the method further includes: outputting prompt information indicating whether to confirm login to the merchant management device; receiving the binding confirmation instruction includes: in response to receiving an instruction to confirm the login to the merchant management device, determining that the binding confirmation instruction is received.

In some examples, the identification code displayed in the merchant management device has time validity; obtaining the device identifier of the merchant management device by scanning the identification code displayed in the merchant management device includes: scanning the identification code displayed in the merchant management device; in response to that the identification code is currently a valid code, obtaining the device identifier of the merchant management device by scanning the identification code; and in response to that the identification code is currently an invalid code, outputting prompt information indicating that the identification code is invalid.

In some examples, after sending the binding confirmation request, the method further includes: receiving and outputting response information indicating that the merchant management device is successfully bound.

In some examples, in response to that it is determined that the security verification fails according to the store information and the login account information, the method further includes: receiving and outputting response information indicating that the merchant management device fails to be bound.

According to another aspect of the present disclosure, there is provided another security processing method for use of a merchant management device, which can be applied to a merchant management device side. The method includes: before entering a system desktop of the merchant management device, acquiring a device identifier of the merchant management device, and sending an identification code generation request carrying the device identifier; receiving an identification code generated according to the device identifier and a polling unique identifier; displaying the identification code; receiving store information that is to be bound, and updating a scan code state according to the store information, where the store information is sent in response to that it is determined that security verification is passed according to the store information and login account information of a scan code client; sending, based on the polling unique identifier, a request for polling whether the store information is successfully bound with device information of the merchant management device; and in response to determining that the store information is successfully bound with the device information, displaying the system desktop.

In some examples, updating the scan code state according to the store information includes: updating the displayed identification code to the store information.

In some examples, the displayed identification code has time validity; displaying the identification code includes: monitoring the time validity of the identification code regularly or irregularly; in response to that the identification code is currently a valid code, continuing displaying the identification code; in response to that the identification code is currently an invalid code, resending the identification code generation request carrying the device identifier; and receiving and displaying a newly generated identification code according to the device identifier.

In some examples, after displaying the system desktop, the method further includes: displaying currently logged-in store information in the merchant management device.

In some examples, in response to that the store information is logged out, the method further includes: resending the identification code generation request carrying the device identifier; receiving and displaying a newly generated identification code; and in response to not receiving scan code response information to the identification code after a preset period of time, triggering the merchant management device to be turned off.

According to another aspect of the present disclosure, there is provided a security processing apparatus for use of a merchant management device, which can be applied to a client side. The apparatus includes:

a scanning module, configured to obtain a device identifier of the merchant management device by scanning an identification code displayed in the merchant management device, where the identification code is generated according to the device identifier before entering a system desktop of the merchant management device;

an acquiring module, configured to acquire login account information and selected store information that is to be bound; and

a sending module, configured to send a notification request carrying the store information, the login account information, and the device identifier, so that in response to that it is determined that security verification is passed according to the store information and the login account information, the store information is forwarded to the merchant management device corresponding to the device identifier to update a scan code state,

where the sending module is further configured to receive a binding confirmation instruction, and send a binding confirmation request, so that the merchant management device, in response to determining that the store information is successfully bound with device information of the merchant management device, displays the system desktop.

In some examples, the sending module is configured to verify whether a login user corresponding to the login account information matches a preset blacklisted user; and/or verify whether the login user is currently in a login state; and/or verify whether the login user has a store management authority of a store corresponding to the store information; and/or verify whether the store corresponding to the store information is in a valid state; in response to determining that the login user matches the preset blacklisted user, or the login user is currently offline, or the login user does not have the store management authority, or the store is in an invalid state, determine that the security verification fails; and in response to determining that the login user does not match the preset blacklisted user, and the login user is currently in the login state, and the login user has the store management authority, and the store is in the valid state, determine that the security verification is passed.

In some examples, the sending module is configured to sign up for store user information included in the store information by using the device information of the merchant management device; add, to store expansion information included in the store information, corresponding store has been bound to the merchant management device; and establish and store an association relationship between the store information and the device information.

In some examples, the apparatus further includes: an outputting module, configured to, before receiving the binding confirmation instruction, output prompt information indicating whether to confirm login to the merchant management device; where the sending module is configured to, in response to receiving an instruction to confirm the login to the merchant management device, determine that the binding confirmation instruction is received.

In some examples, the identification code displayed in the merchant management device has time validity; the scanning module is configured to scan the identification code displayed in the merchant management device; in response to that the identification code is currently a valid code, obtain the device identifier of the merchant management device by scanning the identification code; and in response to that the identification code is currently an invalid code, output prompt information indicating that the identification code is invalid.

In some examples, the apparatus further includes: an outputting module, configured to, after sending the binding confirmation request, receive and output response information indicating that the merchant management device is successfully bound.

In some examples, the apparatus further includes: an outputting module, configured to, in response to that it is determined that the security verification fails according to the store information and the login account information, receive and output response information indicating that the merchant management device fails to be bound.

According to another aspect of the present disclosure, there is provided a security processing apparatus for use of a merchant management device, which can be applied to a merchant management device side. The apparatus includes: a sending module, configured to, before entering a system desktop of the merchant management device, acquire a device identifier of the merchant management device, and send an identification code generation request carrying the device identifier; a receiving module, configured to receive an identification code generated according to the device identifier and a polling identifier; and a display module, configured to display the identification code; where the receiving module is further configured to receive store information that is to be bound, and update a scan code state according to the store information, where the store information is sent in response to that it is determined that security verification is passed according to the store information and login account information of a scan code client; the sending module is further configured to send, based on the polling identifier, a request for polling whether the store information is successfully bound with device information of the merchant management device; and the display module is further configured to, in response to determining that the store information is successfully bound with the device information, display the system desktop.

In some examples, the receiving module is configured to update the displayed identification code to the store information.

In some examples, the displayed identification code has time validity; the display module is configured to monitor the time validity of the identification code regularly or irregularly; in response to that the identification code is currently a valid code, continue displaying the identification code; in response to that the identification code is currently an invalid code, resend the identification code generation request carrying the device identifier; and receive and display a newly generated identification code according to the device identifier.

In some examples, the display module is further configured to, after displaying the system desktop, display currently logged-in store information in the merchant management device.

In some examples, the apparatus further includes: a triggering module, where the sending module is further configured to, in response to that the store information is logged out, resend the identification code generation request carrying the device identifier; the receiving module is further configured to receive and display a newly generated identification code; the triggering module is configured to, in response to not receiving scan code response information to the identification code after a preset period of time, trigger the merchant management device to be turned off.

According to another aspect of the present disclosure, there is provided a non-transitory readable storage medium, having computer readable instructions stored thereon, where the computer readable instructions are executed by a processor to implement the security processing method for use of a merchant management device which can be applied to a client side. According to another aspect of the present disclosure, there is provided a client device, including: a non-transitory readable storage medium, a processor, and computer readable instructions stored on the storage medium and runnable on the processor, where the computer readable instructions are executed by the processor to implement the security processing method for use of a merchant management device which can be applied to a client side.

According to another aspect of the present disclosure, there is provided a non-transitory readable storage medium, having computer readable instructions stored thereon, where the computer readable instructions are executed by a processor to implement the security processing method for use of a merchant management device which can be applied to a merchant management device side. According to another aspect of the present disclosure, there is provided a merchant management device, including: a non-transitory readable storage medium, a processor, and computer readable instructions stored on the non-transitory readable storage medium and runnable on the processor, where the computer readable instructions are executed by the processor to implement the security processing method for use of a merchant management device which can be applied to a merchant management device side.

According to another aspect of the present disclosure, there is provided a security processing system for use of a merchant management device, including: the client device, the merchant management device, and a server, where the server is configured to receive an identification code generation request sent by the merchant management device, the generation request carrying a device identifier of the merchant management device, and the generation request being sent before entering a system desktop of the merchant management device; generate an identification code and a polling unique identifier according to the device identifier; send the identification code and the polling unique identifier to the merchant management device, so that the merchant management device displays the identification code; receive a notification request sent by the client device, the notification request carrying selected store information that is to be bound, login account information of the client device, and the device identifier of the merchant management device obtained by scanning the identification code; in response to determining that security verification is passed according to the store information and the login account information, forward the store information to the merchant management device corresponding to the device identifier to update a scan code state; receive a binding confirmation request sent by the client device to bind the store information with device information of the merchant management device, and in response to receiving a request for polling a binding result sent by the merchant management device based on the polling unique identifier, feed back response information indicating that binding is successful, so that the merchant management device displays the system desktop.

With the above technical solutions, a security processing method, apparatus and system for use of a merchant management device are provided in the present disclosure. Compared with current prior art, according to the present disclosure, the identification code can be generated according to the device identifier of the merchant management device before the system desktop of the merchant management device is entered, and the user, only after logging in by scanning the code and successfully passing the security verification according to the selected store information that is to be bound and the login account information, can further enter and use the system desktop of the merchant management device, which adds the security verification mechanism to the merchant management device and reduces the possibility of potential security risks. By using a manner of binding according to the device+the store to perform the login process of the merchant management device, the use security of the merchant management device can be effectively improved.

The above description is only a summary of the technical solutions of the present disclosure. In order to understand the technical means of the disclosure more clearly, it can be implemented in accordance with the contents of the specification, and in order to make the above and other objects, features and advantages of this disclosure more obvious and understandable, specific implementations of the present disclosure are illustrated below.

### BRIEF DESCRIPTION OF THE DRAWINGS

The drawings described here are used to provide further understanding of the present disclosure and constitute a part of the disclosure. The examples of the present disclosure and the description thereof are used to explain the disclosure and do not constitute an improper limitation to the disclosure. In the drawings:

FIG. 1 is a schematic flowchart illustrating a security processing method for use of a merchant management device according to an example of the present disclosure.

FIG. 2 is a schematic flowchart illustrating another security processing method for use of a merchant management device according to an example of the present disclosure.

FIG. 3 is a schematic flowchart illustrating an implementation architecture of a solution example according to an example of the present disclosure.

FIG. 4 is a schematic structural diagram illustrating a security processing apparatus for use of a merchant management device according to an example of the present disclosure.

FIG. 5 is a schematic structural diagram illustrating another security processing apparatus for use of a merchant management device according to an example of the present disclosure.

FIG. 6 is a schematic structural diagram illustrating yet another security processing apparatus for use of a merchant management device according to an example of the present disclosure.

FIG. 7 is a schematic structural diagram illustrating still another security processing apparatus for use of a merchant management device according to an example of the present disclosure.

FIG. 8 is a schematic diagram illustrating a system architecture of a security processing system for use of a merchant management device according to an example of the present disclosure.

### DETAILED DESCRIPTION OF THE EMBODIMENTS

Hereinafter, the present disclosure will be described in detail with reference to the drawings and in conjunction with the examples. It should be noted that the examples in the disclosure and the features in the examples can be combined with each other in a case of no conflict.

In view of the problem that current merchant management devices lack a security verification mechanism, a security processing method for use of a merchant management device is provided according an example. The method can be applied to a client side. As shown in FIG. 1, the method includes:

At 101, a device identifier (Device ID) of the merchant management device is obtained by scanning an identification code displayed in the merchant management device by a client.

The identification code is generated according to the device identifier of the merchant management device before entering a system desktop of the merchant management device. The identification code may be a one-dimensional bar code, a two-dimensional code, or other multi-dimensional bar codes. In this example, the merchant management device may be, for example or preferably, a POS device or other terminals. After the merchant management device is turned on and its network is successfully configured, the identification code can be generated based on the device identifier through a server and corresponding code value is fed back to the merchant management device, so that the merchant management device renders and displays the identification code according to the code value. Users are prompted to scan the code to log in. If the code is not scanned to log in, the system desktop of the merchant management device cannot be further entered, that is, the merchant management device cannot be used. An execution subject in this example may be a client apparatus or device with a code scanning function, which is used to assist to scan the code to log in to the merchant management device so that security processing for use of the merchant management device can be performed.

At 102, login account information and selected store information that is to be bound are acquired. The login account information is account information of current login client. The store information may include a name, an address, a photo, etc. of a store. It should be noted that in this example, the store refers to an online store, instead of an offline physical store. For this example, store information that can be bound is displayed in the client, and then a user selects the store information that is to be bound, that is, the user selects which store to be logged in to the merchant management device.

At 103, a notification request carrying the acquired store information and login account information, and the device identifier of the merchant management device is sent.

Further, the server, when determining that security verification is passed according to the store information and the login account information, forwards the store information to the merchant management device corresponding to the device identifier to update a scan code state. For example, it is determined whether a user who is operating login is secure according to login account information, and it is determined whether the store is secure to be logged in to the merchant management device according to the store information, and so on. When it is determined that the security verification is passed, the store information is forwarded to corresponding merchant management device, so that the merchant management device can update the scan code state according to the store information, and further the user who scanned the code can learn that the code is successfully scanned, and the store that is to be logged in to the merchant management device is the store that he/she selects to bind. By way of updating the scan code state, the user experience can be enhanced, and the user can be notified in time whether the code is successfully scanned, which avoids the user from repeating the code scanning process.

At 104, a binding confirmation instruction is received, and a binding confirmation request is sent.

Further, the merchant management device, when determining that the selected store information that is to be bound is successfully bound with device information of the merchant management device, displays the system desktop of the merchant management device.

In this example, the client, which scanned the code, confirms whether to bind according to a user input instruction, and the merchant management device uses a regular or irregular polling manner to poll the server whether the store information with updated current state is successfully bound with the device information of the merchant management device. If it is polled that the binding is successful, the system desktop of the merchant management device will be displayed, so that the user can use the merchant management device. Compared with current prior art, according to the security processing method for use of the merchant management device provided in this example, which can be applied to the client side, the identification code can be generated according to the device identifier of the merchant management device before the system desktop of the merchant management device is entered, and the user, only after logging in by scanning the code and successfully passing the security verification according to the selected store information that is to be bound and the login account information, can further enter and use the system desktop of the merchant management device, which adds the security verification mechanism to the merchant management device and reduces the possibility of potential security risks. By using a manner of binding according to the device+the store to perform the login process of the merchant management device, the use security of the merchant management device can be effectively improved.

Further, as refinement and expansion of specific implementation of the above example, in order to illustrate the security verification process, as an alternative, performing the security verification according to the store information and the login account information may include: verifying whether a login user corresponding to the login account information matches a preset blacklisted user; and/or verifying whether the login user is currently in a login state; and/or verifying whether the login user has a store management authority of a store corresponding to the store information; and/or verifying whether the store corresponding to the store information is in a valid state.

Based on the above verification manner, if it is determined that the login user matches the preset blacklisted user, or the login user is currently offline, or the login user does not have the store management authority corresponding to the store, or the store is in an invalid state, it is determined that the security verification fails; if it is determined that the login user does not match the preset blacklisted user, and the login user is currently in the login state, and the login user has the store management authority corresponding to the store, and the store is in the valid state, it is determined that the security verification is passed. In this alternative, specific contents of verification rules can be selected and set according to actual needs, and one or more of the verification rules can be selected for performing the security verification. It should be noted that the more the verification rules are, the more accurate the corresponding security verification results are. In addition to the verification rules, other verification manners, for example, a manner of filtering verification through a preset whitelist, can be set according to actual needs, which is not limited herein. For example, which users are blacklisted users can be preset according to actual needs. If the login user is a blacklisted user, it indicates that there exist certain security risks, so that security verification is not passed. If the login user is currently offline, there also exist certain security risks to maintain login to the merchant management device of the user. Or, if the login user does not have the store management authority of the store (users who have the store management authority of the store have been pre-collected), it indicates that the user has no qualification to participate in store management using the merchant management device, so that security verification is not passed. A manager of a store can set whether the store is allowed to use the merchant management device by scanning the code to log in. If the manager of the store sets that the store is allowed to use the merchant management device by scanning the code to log in, and the store has been registered on the server and is currently operating, it indicates that the store is valid. If the manager of the store sets that the store is not allowed to use the merchant management device by scanning the code to log in, or the store is not registered or has been currently closed, it indicates that the store is invalid, so that security verification is not passed.

In this alternative, when the user scans the code to log in to the merchant management device, accurate security verification can be achieved, which ensures the use security of the merchant management device.

In order to illustrate the specific binding process, as an alternative, binding the store information with the device information of the merchant management device includes: signing up for store user information included in the store information by using the device information of the merchant management device; adding, to store expansion information included in the store information, corresponding store has been bound to the merchant management device; and establishing and storing an association relationship between the store information and the device information of the merchant management device, which, specifically, can be stored persistently in a database. According to the binding manner of signing a contract, marking, and putting in storage, both the device+the store are bound, which can ensure that the store accurately logs in to the merchant management device, and subsequently the merchant management device can be used accurately.

Further, in order to achieve user operability, as an alternative, before the step 104, the method may further include: outputting prompt information indicating whether to confirm login to the merchant management device; correspondingly, receiving the binding confirmation instruction in the step 104 may include: when receiving an instruction to confirm the login to the merchant management device, determining that the binding confirmation instruction is received. For example, when a user successfully scans a two-dimensional code displayed in the merchant management device through the client, prompt information indicating whether to log in to the merchant management device with this device identifier pops up on a page of the client, and the user confirms whether to log in. If the user inputs a login instruction, the client sends a binding request to the server.

In order to ensure certain security and avoid the displayed identification code from being remotely operated, as an alternative, the identification code displayed in the merchant management device has time validity; correspondingly, the step 101 may include: scanning the identification code displayed in the merchant management device; if the identification code is currently a valid code, obtaining the device identifier of the merchant management device by scanning the identification code; and if the identification code is currently an invalid code, outputting prompt information indicating that the identification code is invalid.

Further, in order to enable a user to learn a binding result in time, after the step 104, the method may further include: receiving and outputting response information indicating that the merchant management device is successfully bound. If it is determined that the security verification fails according to the store information and the login account information, the method in this example may further include: receiving and outputting response information indicating that the merchant management device fails to be bound.

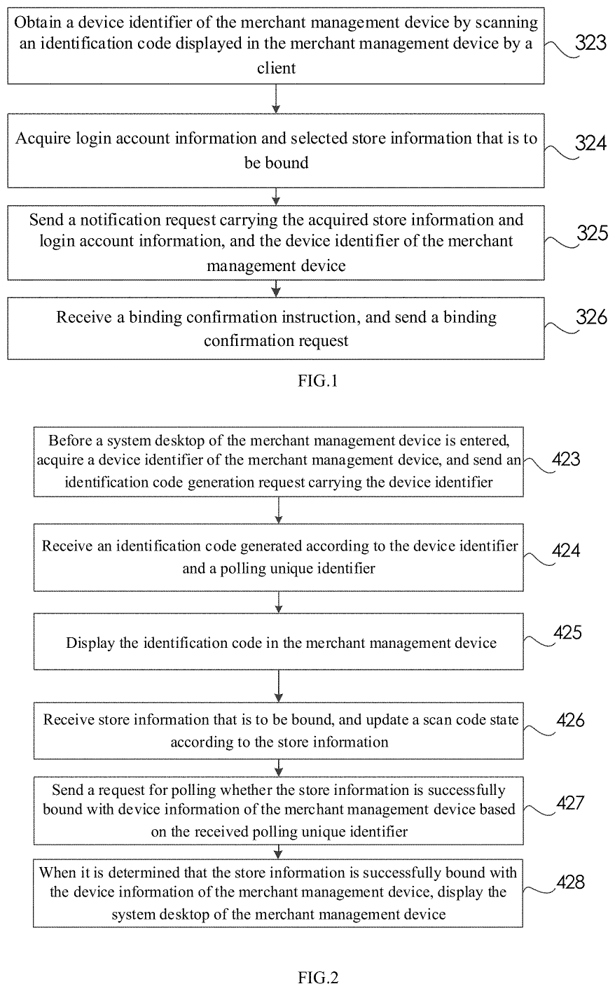

It should be noted that the security processing method for use of the merchant management device, which can be applied to the client side, describes the specific use security processing of the merchant management device on the client side, and in order to fully explain the specific implementation of this example, there is provided another security processing method for use of the merchant management device, which can be applied to a merchant management device side, to illustrate the use security processing of the merchant management device on the merchant management device side. As shown in FIG. 2, the method includes:

At 201, before a system desktop of the merchant management device is entered, a device identifier of the merchant management device is acquired, and an identification code generation request carrying the device identifier is sent.

The device identifier may include: MODEL, MANUFACTURER, SERIAL, etc. An execution subject on this side may be a client installed on the merchant management device side for use security processing of the merchant management device.

At 202, an identification code generated according to the device identifier and a polling unique identifier are received.

After the merchant management device is turned on and its network is successfully configured, and before the system desktop of the merchant management device is entered, the device identifier of the merchant management device can be submitted to the server, and the server generates the identification code according to the device identifier and corresponding code value is returned to the merchant management device side.

In addition, the server will further generate a universal Device ID, i.e., a polling unique identifier, for use in subsequent polling according to the device identifier of the merchant management device. For example, the Device ID can be obtained by combining such as concatenating the three identifiers, MODEL, MANUFACTURER and SERIAL.

At 203, the identification code is displayed in the merchant management device.

The merchant management device renders and displays the identification code according to the code value. In this example, if the code is not scanned successfully to log in to the merchant management device, the system desktop of the merchant management device cannot be further entered, that is, the merchant management device cannot be used.

At 204, store information that is to be bound is received, and a scan code state is updated according to the store information.

The received store information is sent when the server determines that security verification is passed according to the store information and login account information of a scan code client. By way of updating the scan code state, the user who scanned the code can learn that the code is successfully scanned, and the store that is to be logged in to the merchant management device is the store that he/she selects to bind. Further, the user experience can be enhanced, and the user can be notified in time whether the code is successfully scanned, which avoids the user from repeating the code scanning process.

At 205, a request for polling whether the store information is successfully bound with device information of the merchant management device is sent based on the received polling unique identifier.

At 206, when it is determined that the store information is successfully bound with the device information of the merchant management device, the system desktop of the merchant management device is displayed.

Specifically, a regular or irregular polling manner can be used. If it is polled that the binding is successful, the system desktop of the merchant management device will be displayed, so that the user can use the merchant management device. If it is polled that the binding is not successful, the polling will be continued subsequently.

Compared with current prior art, according to the security processing method for use of the merchant management device provided in this example, which can be applied to the merchant management device side, the identification code can be generated according to the device identifier of the merchant management device before the system desktop of the merchant management device is entered, and the user, only after logging in by scanning the code and successfully passing the security verification according to the selected store information that is to be bound and the login account information, can further enter and use the system desktop of the merchant management device, which adds the security verification mechanism to the merchant management device and reduces the possibility of potential security risks. By using a manner of binding according to the device+the store to perform the login process of the merchant management device, the use security of the merchant management device can be effectively improved.

Further, as refinement and expansion of specific implementation of the above example, in order to illustrate the specific implementation process of updating the scan code state in the step 204, as an alternative, updating the scan code state according to the received store information may include: updating the displayed identification code to the store information.

For example, a name, an address, a photo, etc. of a store included in the store information are acquired. The identification code displayed in the merchant management device is replaced with an icon of the store photo, and the name and address of the store are marked thereon, so that a user who scanned the code can learn in time that the code is successfully scanned, and the store that is to be logged in to the merchant management device is the store that he/she selects to bind. Further, the merchant management device may output information prompting the user to confirm the login as soon as possible, and instruct the user to perform next operation quickly. In addition, a timeout mechanism can be set. That is, if it is polled that the binding is still not successful after a period of time, it is determined that the code scanning operation has failed, and subsequently it will not be polled whether the binding process is successful. If the user who scanned the code still desires to log in to the merchant management device, he/she is to scan the code again. In this way, certain security can be ensured, and potential security risks caused by login timeout can be avoided.

Similarly, in order to ensure certain security and avoid the displayed identification code from being remotely operated, as an alternative, the identification code displayed in the merchant management device has time validity; under this condition, in order to maximize the code scanning success rate of users who scanned the code, correspondingly, the step 203 may include: monitoring the time validity of the identification code regularly or irregularly; if the identification code is currently a valid code, continuing displaying the identification code; if the identification code is currently an invalid code, resending the identification code generation request carrying the device identifier of the merchant management device; then receiving and displaying an identification code newly generated by a server according to the device identifier of the merchant management device. In this way, it can be ensured that the validity of the identification code is guaranteed before the user scans the code, and the user is avoided from scanning an invalid code and then clicking “re-acquire” or other operations, which can improve certain code scanning efficiency.

Further, after the system desktop of the merchant management device is successfully displayed, in order to enable a user, who currently uses the merchant management device, to know a login party of the merchant management device, as an alternative, the method may further include: displaying currently logged-in store information in the merchant management device. Thereby, the user, who currently uses the merchant management device, knows that the login party of the merchant management device is the store previously selected to bind.

Further, if the store information is logged out, the method in this example may further include: resending the identification code generation request carrying the device identifier of the merchant management device; receiving and displaying a newly generated identification code; if not receiving scan code response information to the newly generated identification code after a preset period of time, triggering the merchant management device to be turned off.

In the merchant management device, if previously logged-in store information is logged out, it returns to an interface displaying the identification code, and the system desktop cannot be entered without scanning the code to log in, which ensures the use security of the merchant management device. Here, when the merchant management device does not receive an operation instruction within a period of time, it can be determined that the store information is logged out, or the store information is manually logged out according to user needs. If the scan code response information to the newly generated identification code is not received after a certain period of time, the merchant management device is triggered to be turned off, which saves the power consumption of the merchant management device.

In order to illustrate the specific implementation process of the above example, the following application scenario is given, but is not limited thereto:

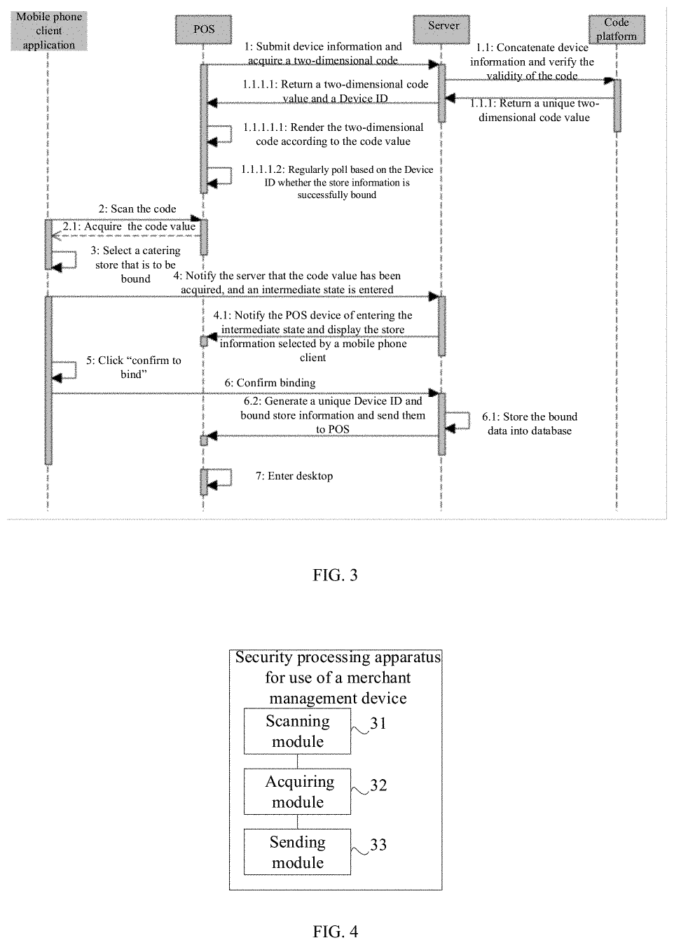

In the catering industry, waiters/waitresses often use POS devices to order food for customers, but the prior art lacks relevant security verification mechanism, so that some non-store employees can also use the POS devices, which causes certain security risks. For this reason, this solution uses a manner of binding according to the device+the store to perform the code scanning login process of the POS devices, as shown in FIG. 3. To begin with, after a POS device is turned on, a device identifier is acquired in a network configuration stage, and a two-dimensional code is generated through a server based on the device identifier. The server uses a code platform to concatenate and verify the validity of the code according to the POS device identifier, and return a two-dimensional code value and a universal Device ID to the POS device. Subsequently, the POS device, before entering its system desktop, uses the two-dimensional code value to render and generate the two-dimensional code for display, and regularly polls based on the Device ID whether the store information is successfully bound.

Then on a user side, if a waiter/waitress desires to use the POS device, he/she can scan the two-dimensional code displayed in the POS device through a mobile phone client, and select a catering store that is to be bound. The server is notified that the code value (POS device identifier) has been acquired, and an intermediate state is entered. When security verification is passed, the server notifies the POS device of entering the intermediate state and displaying the store information selected by a mobile phone client. Subsequently, the waiter/waitress can click “confirm to bind” in the mobile phone client, and instruct the server to bind and store the store information and the POS device information into a database. When the POS device polls that the binding is successful, it will display and provide the system desktop to the waiter/waitress for use.

In this way, the use security of the POS device can be ensured, and the POS device will not be used by other users who are non-store employees, reducing the possibility of potential security risks, and guaranteeing the property security of the catering store to a certain extent.

Further, as specific implementation of the method shown in FIG. 1, according to an example of the present disclosure, there is provided a security processing apparatus for use of a merchant management device which can be applied to a client side. As shown in FIG. 4, the apparatus includes: a scanning module 31, an acquiring module 32, and a sending module 33.

The scanning module 31 is configured to scan an identification code displayed in the merchant management device to obtain a device identifier of the merchant management device, where the identification code is generated according to the device identifier before entering a system desktop of the merchant management device; the acquiring module 32 is configured to acquire login account information and selected store information that is to be bound; the sending module 33 is configured to send a notification request carrying the store information, the login account information, and the device identifier. Further, when it is determined that security verification is passed according to the store information and the login account information, the store information is forwarded to the merchant management device corresponding to the device identifier to update a scan code state,

The sending module 33 is further configured to receive a binding confirmation instruction, and send a binding confirmation request.

Further, the merchant management device, when determining that the store information is successfully bound with device information of the merchant management device, displays the system desktop. In a specific application scenario, the sending module 33 is configured to verify whether a login user corresponding to the login account information matches a preset blacklisted user; and/or verify whether the login user is currently in a login state; and/or verify whether the login user has a store management authority of a store corresponding to the store information; and/or verify whether the store corresponding to the store information is in a valid state; if determining that the login user matches the preset blacklisted user, or the login user is currently offline, or the login user does not have the store management authority, or the store is in an invalid state, determine that the security verification fails; if determining that the login user does not match the preset blacklisted user, and the login user is currently in the login state, and the login user has the store management authority, and the store is in the valid state, determine that the security verification is passed.

In a specific application scenario, the sending module 33 is configured to sign up for store user information included in the store information by using the device information of the merchant management device; add, to store expansion information included in the store information, corresponding store has been bound to the merchant management device; and establish and store an association relationship between the store information and the device information.

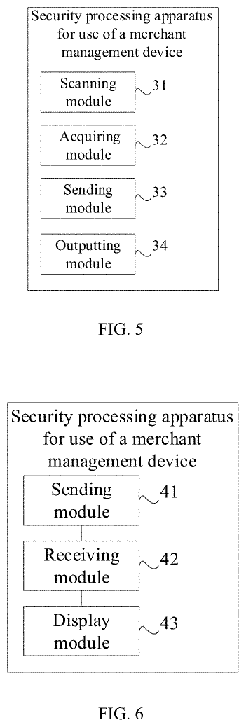

In a specific application scenario, as shown in FIG. 5, the apparatus further includes: an outputting module 34, configured to, before receiving the binding confirmation instruction, output prompt information indicating whether to confirm login to the merchant management device; where the sending module 33 is configured to, when receiving an instruction to confirm the login to the merchant management device, determine that the binding confirmation instruction is received.

In a specific application scenario, the identification code displayed in the merchant management device has time validity; correspondingly, the scanning module 31 is configured to scan the identification code displayed in the merchant management device; if the identification code is currently a valid code, obtain the device identifier of the merchant management device by scanning the identification code; and if the identification code is currently an invalid code, output prompt information indicating that the identification code is invalid.

In a specific application scenario, the outputting module 34 is further configured to, after sending the binding confirmation request, receive and output response information indicating that the merchant management device is successfully bound.

In a specific application scenario, the outputting module 34 is further configured to, if it is determined that the security verification fails according to the store information and the login account information, receive and output response information indicating that the merchant management device fails to be bound.

It should be noted that for other corresponding descriptions of functional units involved in the security processing apparatus for use of the merchant management device provided in this example, which can be applied to the client side, reference may be made to corresponding description of the method in FIG. 1, which will not be repeated herein.

Further, as specific implementation of the method shown in FIG. 2, according to an example of the present disclosure, there is provided a security processing apparatus for use of a merchant management device which can be applied to a merchant management device side. As shown in FIG. 6, the apparatus includes: a sending module 41, a receiving module 42, and a display module 43.

The sending module 41 is configured to, before entering a system desktop of the merchant management device, acquire a device identifier of the merchant management device, and send an identification code generation request carrying the device identifier.

The receiving module 42 is configured to receive an identification code generated according to the device identifier and a polling identifier.

The display module 43 is configured to display the identification code.

The receiving module 42 is further configured to receive store information that is to be bound, and update a scan code state according to the store information, where the store information is sent when it is determined that security verification is passed according to the store information and login account information of a scan code client.

The sending module 41 is further configured to send, based on the polling identifier, a request for polling whether the store information is successfully bound with device information of the merchant management device.

The display module 43 is further configured to, when determining that the store information is successfully bound with the device information, display the system desktop.

In a specific application scenario, the receiving module 42 is configured to update the displayed identification code to the store information.

In a specific application scenario, the displayed identification code has time validity; correspondingly, the display module 43 is configured to monitor the time validity of the identification code regularly or irregularly; if the identification code is currently a valid code, continue displaying the identification code; if the identification code is currently an invalid code, resend the identification code generation request carrying the device identifier; receive and display a newly generated identification code according to the device identifier.

In a specific application scenario, the display module 43 is further configured to, after displaying the system desktop, display currently logged-in store information in the merchant management device.

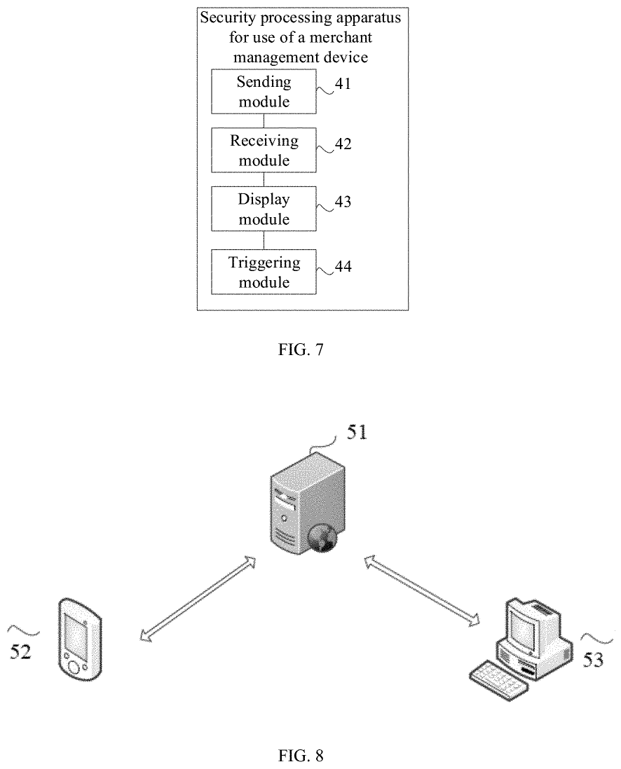

In a specific application scenario, as shown in FIG. 7, the apparatus further includes: a triggering module 44, where the sending module 41 is further configured to, if the store information is logged out, resend the identification code generation request carrying the device identifier; the receiving module 42 is further configured to receive and display a newly generated identification code; the triggering module 44 is configured to, if not receiving scan code response information to the identification code after a preset period of time, trigger the merchant management device to be turned off.

It should be noted that for other corresponding descriptions of functional units involved in the security processing apparatus for use of the merchant management device provided in the example of the present disclosure, which can be applied to the merchant management device side, reference may be made to corresponding description of the method in FIG. 2, which will not be repeated herein.

Based on the method shown in FIG. 1, correspondingly, according to an example of the present disclosure, there is provided a non-transitory readable storage medium, having computer readable instructions stored thereon, where the computer readable instructions are executed by a processor to implement the security processing method for use of a merchant management device as shown in FIG. 1. Based on the method shown in FIG. 2, according to an example of the present disclosure, there is further provided another non-transitory readable storage medium, having computer readable instructions stored thereon, where the computer readable instructions are executed by a processor to implement the security processing method for use of a merchant management device as shown in FIG. 2.

Based on such understanding, the technical solutions of the present disclosure can be embodied in the form of a software product. The software product can be stored in a non-transitory storage medium (which may be a CD-ROM, a U disk, a mobile hard disk, etc.), including several instructions to cause a computer device (which may be a personal computer, a server, or a network device, etc.) execute a method for pushing novice guidance information of each implementation scenario of the present disclosure. Based on the method shown in FIG. 1 and the virtual apparatus examples shown in FIG. 4 and FIG. 5, in order to achieve the above object, according to an example of the present disclosure, there is provided a client device, which may be a personal computer, a tablet computer, a smart phone, a smart watch, a smart bracelet, or other network devices. The client device includes a non-transitory readable storage medium and a processor. The non-transitory readable storage medium is used to store computer readable instructions. The processor is used to execute computer readable instructions to implement the security processing method for use of the merchant management device shown in FIG. 1. Based on the method shown in FIG. 2 and the virtual apparatus examples shown in FIG. 6 and FIG. 7, in order to achieve the above object, a merchant management device is provided according to an example of the present disclosure. The merchant management device includes a non-transitory readable storage medium and a processor. The non-transitory readable storage medium is used to store computer readable instructions. The processor is used to execute computer readable instructions to implement the security processing method for use of the merchant management device shown in FIG. 2.

In some examples, both of the above two physical devices may further include a user interface, a network interface, a camera, a radio frequency (RF) circuit, a sensor, an audio circuit, a WI-FI module, and so on. The user interface may include a display, an input unit such as a keyboard. In some examples, the user interface may further include a USB interface, a card reader interface, and the like. In some examples, the network interface may include a standard wired interface, a wireless interface (such as a WI-FI interface) and so on.

Those skilled in the art can understand that physical device structures of a client device and a merchant management device provided in this example do not constitute a limitation on these two physical devices, and may include more or fewer components, or a combination of some components, or different component arrangements.

The storage medium may further include an operating system and a network communication module. The operating system is a program that manages hardware and software resources of the above two physical devices, and supports operation of information processing programs and other software and/or programs. The network communication module is used to realize communication between various components in the storage medium, and communication with other hardware and software in information processing physical devices.

Based on the above contents, further, a security processing system for use of a merchant management device is provided according to an example of the present disclosure. As shown in FIG. 8, the system includes a server 51, a client device 52, and a merchant management device 53.

The client device 52 can be used to execute the method shown in FIG. 1. The merchant management device 53 can be used to execute the method shown in FIG. 2. The server 51 is used to receive an identification code generation request sent by the merchant management device 53, the generation request carrying a device identifier of the merchant management device 53, and the generation request being sent before entering a system desktop of the merchant management device 53; generate an identification code and a polling unique identifier according to the device identifier; send the identification code and the polling unique identifier to the merchant management device 53, so that the merchant management device 53 displays the identification code; receive a notification request sent by the client device 52, the notification request carrying selected store information that is to be bound, login account information of the client device 52, and the device identifier of the merchant management device 53 obtained by scanning the identification code; when determining that security verification is passed according to the store information and the login account information, forward the store information to the merchant management device 53 corresponding to the device identifier to update a scan code state; receive a binding confirmation request sent by the client device 52 to bind the store information with device information of the merchant management device, and when receiving a request for polling a binding result sent by the merchant management device 53 based on the polling unique identifier, feed back response information indicating that binding is successful, so that the merchant management device 53 displays the system desktop.

Through the description of the above implementation manners, those skilled in the art can clearly understand that the present disclosure can be implemented by means of software plus a necessary general hardware platform, or by hardware. By applying the technical solutions of this disclosure, compared with current prior art, the identification code can be generated according to the device identifier of the merchant management device before the system desktop of the merchant management device is entered, and the user, only after logging in by scanning the code and successfully passing the security verification according to the selected store information that is to be bound and the login account information, can further enter and use the system desktop of the merchant management device, which adds the security verification mechanism to the merchant management device and reduces the possibility of potential security risks. By using a manner of binding according to the device+the store to perform the login process of the merchant management device, the use security of the merchant management device can be effectively improved.

Those skilled in the art can understand that the drawings are only schematic diagrams of preferred implementation scenarios, and the modules or processes in the drawings are not necessarily essential for implementing this disclosure. Those skilled in the art can understand that modules in an apparatus in an implementation scenario can be distributed in the apparatus in the implementation scenario according to description of the implementation scenario, or can be changed correspondingly to be located in one or more apparatuses different from the implementation scenario. The modules in the above implementation scenario can be combined into one module or further divided into multiple sub-modules. The serial number of the disclosure is only for description, and does not represent pros and cons of implementation scenarios. Disclosed above are only a few specific implementation scenarios of the disclosure, but the disclosure is not limited thereto, and any changes that can be thought of by those skilled in the art should fall into the protection scope of the disclosure.

1. A security processing method for use of a merchant management device, comprising:
obtaining a device identifier of the merchant management device by scanning an identification code displayed in the merchant management device, wherein the identification code is generated according to the device identifier before entering a system desktop of the merchant management device;
acquiring login account information and selected store information that is to be bound;
sending a notification request carrying the store information, the login account information, and the device identifier, so that in response to that it is determined that security verification is passed according to the store information and the login account information, the store information is forwarded to the merchant management device corresponding to the device identifier to update a scan code state; and
receiving a binding confirmation instruction, and sending a binding confirmation request, so that the merchant management device, in response to determining that the store information is successfully bound with device information of the merchant management device, displays the system desktop.

2. The method of claim 1, wherein performing the security verification according to the store information and the login account information comprises:
verifying whether a login user corresponding to the login account information matches a preset blacklisted user; and/or
verifying whether the login user is currently in a login state; and/or
verifying whether the login user has a store management authority of a store corresponding to the store information; and/or
verifying whether the store corresponding to the store information is in a valid state;
in response to determining that the login user matches the preset blacklisted user, or the login user is currently offline, or the login user does not have the store management authority, or the store is in an invalid state, determining that the security verification fails; and
in response to determining that the login user does not match the preset blacklisted user, and the login user is currently in the login state, and the login user has the store management authority, and the store is in the valid state, determining that the security verification is passed.

3. The method of claim 1, wherein binding the store information with the device information of the merchant management device comprises:
signing up for store user information included in the store information by using the device information of the merchant management device;
adding, to store expansion information included in the store information, corresponding store has been bound to the merchant management device; and
establishing and storing an association relationship between the store information and the device information.

4. The method of claim 1, wherein before receiving the binding confirmation instruction, the method further comprises:
outputting prompt information indicating whether to confirm login to the merchant management device;
receiving the binding confirmation instruction comprises:
in response to receiving an instruction to confirm the login to the merchant management device, determining that the binding confirmation instruction is received.

5. The method of claim 1, wherein the identification code displayed in the merchant management device has time validity;
obtaining the device identifier of the merchant management device by scanning the identification code displayed in the merchant management device comprises:
scanning the identification code displayed in the merchant management device;
in response to that the identification code is currently a valid code, obtaining the device identifier of the merchant management device by scanning the identification code; and
in response to that the identification code is currently an invalid code, outputting prompt information indicating that the identification code is invalid.

6. The method of claim 1, wherein after sending the binding confirmation request, the method further comprises:
receiving and outputting response information indicating that the merchant management device is successfully bound.

7. The method of claim 1, wherein in response to that it is determined that the security verification fails according to the store information and the login account information, the method further comprises:
receiving and outputting response information indicating that the merchant management device fails to be bound.

8. A security processing method for use of a merchant management device, comprising:
before entering a system desktop of the merchant management device, acquiring a device identifier of the merchant management device, and sending an identification code generation request carrying the device identifier;
receiving an identification code generated according to the device identifier and a polling unique identifier;
displaying the identification code;
receiving store information that is to be bound, and updating a scan code state according to the store information, wherein the store information is sent in response to that it is determined that security verification is passed according to the store information and login account information of a scan code client;
sending, based on the polling unique identifier, a request for polling whether the store information is successfully bound with device information of the merchant management device; and
in response to determining that the store information is successfully bound with the device information, displaying the system desktop.

9. The method of claim 8, wherein updating the scan code state according to the store information comprises:
updating the displayed identification code to the store information.

10. The method of claim 8, wherein the displayed identification code has time validity;
displaying the identification code comprises:
monitoring the time validity of the identification code regularly or irregularly;
in response to that the identification code is currently a valid code, continuing displaying the identification code;
in response to that the identification code is currently an invalid code, resending the identification code generation request carrying the device identifier; and
receiving and displaying a newly generated identification code according to the device identifier.

11. The method of claim 8, wherein after displaying the system desktop, the method further comprises:
displaying currently logged-in store information in the merchant management device.

12. The method of claim 11, wherein in response to that the store information is logged out, the method further comprises:
resending the identification code generation request carrying the device identifier;
receiving and displaying a newly generated identification code; and
in response to not receiving scan code response information to the identification code after a preset period of time, triggering the merchant management device to be turned off.

13. A security processing apparatus for use of a merchant management device, comprising:
a scanning module, configured to obtain a device identifier of the merchant management device by scanning an identification code displayed in the merchant management device, wherein the identification code is generated according to the device identifier before entering a system desktop of the merchant management device;
an acquiring module, configured to acquire login account information and selected store information that is to be bound; and
a sending module, configured to send a notification request carrying the store information, the login account information, and the device identifier, so that in response to that it is determined that security verification is passed according to the store information and the login account information, the store information is forwarded to the merchant management device corresponding to the device identifier to update a scan code state,
wherein the sending module is further configured to receive a binding confirmation instruction, and send a binding confirmation request, so that the merchant management device, in response to determining that the store information is successfully bound with device information of the merchant management device, displays the system desktop.

14. The apparatus of claim 13, wherein the sending module is configured to
verify whether a login user corresponding to the login account information matches a preset blacklisted user; and/or
verify whether the login user is currently in a login state; and/or
verify whether the login user has a store management authority of a store corresponding to the store information; and/or
verify whether the store corresponding to the store information is in a valid state;
in response to determining that the login user matches the preset blacklisted user, or the login user is currently offline, or the login user does not have the store management authority, or the store is in an invalid state, determine that the security verification fails; and
in response to determining that the login user does not match the preset blacklisted user, and the login user is currently in the login state, and the login user has the store management authority, and the store is in the valid state, determine that the security verification is passed.

15. The apparatus of claim 13, wherein the sending module is configured to:
sign up for store user information included in the store information by using the device information of the merchant management device;
add, to store expansion information included in the store information, corresponding store has been bound to the merchant management device; and
establish and store an association relationship between the store information and the device information.

16. The apparatus of claim 13, further comprises:
an outputting module, configured to, before receiving the binding confirmation instruction, output prompt information indicating whether to confirm login to the merchant management device;
wherein the sending module is configured to, in response to receiving an instruction to confirm the login to the merchant management device, determine that the binding confirmation instruction is received.

17. The apparatus of claim 13, wherein the identification code displayed in the merchant management device has time validity;
the scanning module is configured to:
scan the identification code displayed in the merchant management device;
in response to that the identification code is currently a valid code, obtain the device identifier of the merchant management device by scanning the identification code; and
in response to that the identification code is currently an invalid code, output prompt information indicating that the identification code is invalid.

18. The apparatus of claim 13, further comprising:
an outputting module, configured to, after sending the binding confirmation request, receive and output response information indicating that the merchant management device is successfully bound.

19. The apparatus of claim 13, further comprising:
an outputting module, configured to, in response to that it is determined that the security verification fails according to the store information and the login account information, receive and output response information indicating that the merchant management device fails to be bound.

20. A security processing apparatus for use of a merchant management device, comprising:
a sending module, configured to, before entering a system desktop of the merchant management device, acquire a device identifier of the merchant management device, and send an identification code generation request carrying the device identifier;
a receiving module, configured to receive an identification code generated according to the device identifier and a polling identifier; and
a display module, configured to display the identification code;
wherein the receiving module is further configured to receive store information that is to be bound, and update a scan code state according to the store information, wherein the store information is sent in response to that it is determined that security verification is passed according to the store information and login account information of a scan code client;
the sending module is further configured to send, based on the polling identifier, a request for polling whether the store information is successfully bound with device information of the merchant management device; and
the display module is further configured to, in response to determining that the store information is successfully bound with the device information, display the system desktop.

21. The apparatus of claim 20, wherein the receiving module is configured to update the displayed identification code to the store information.

22. The apparatus of claim 20, wherein the displayed identification code has time validity;
the display module is configured to:
monitor the time validity of the identification code regularly or irregularly;
in response to that the identification code is currently a valid code, continue displaying the identification code;
in response to that the identification code is currently an invalid code, resend the identification code generation request carrying the device identifier; and
receive and display a newly generated identification code according to the device identifier.

23. The apparatus of claim 20, wherein the display module is further configured to, after displaying the system desktop, display currently logged-in store information in the merchant management device.

24. The apparatus of claim 23, further comprising: a triggering module,
wherein the sending module is further configured to, in response to that the store information is logged out, resend the identification code generation request carrying the device identifier;
the receiving module is further configured to receive and display a newly generated identification code; and
the triggering module is configured to, in response to not receiving scan code response information to the identification code after a preset period of time, trigger the merchant management device to be turned off.

25. A non-transitory readable storage medium, having computer readable instructions stored thereon, wherein the computer readable instructions are executed by a processor to implement a security processing method for use of a merchant management device, which comprises:
obtaining a device identifier of the merchant management device by scanning an identification code displayed in the merchant management device, wherein the identification code is generated according to the device identifier before entering a system desktop of the merchant management device;
acquiring login account information and selected store information that is to be bound;
sending a notification request carrying the store information, the login account information, and the device identifier, so that in response to that it is determined that security verification is passed according to the store information and the login account information, the store information is forwarded to the merchant management device corresponding to the device identifier to update a scan code state; and
receiving a binding confirmation instruction, and sending a binding confirmation request, so that the merchant management device, in response to determining that the store information is successfully bound with device information of the merchant management device, displays the system desktop.

26. A client device, comprising: a non-transitory readable storage medium, a processor, and computer readable instructions stored on the storage medium and runnable on the processor, wherein the computer readable instructions are executed by the processor to implement a security processing method for use of a merchant management device, which comprises:
obtaining a device identifier of the merchant management device by scanning an identification code displayed in the merchant management device, wherein the identification code is generated according to the device identifier before entering a system desktop of the merchant management device;
acquiring login account information and selected store information that is to be bound;
sending a notification request carrying the store information, the login account information, and the device identifier, so that in response to that it is determined that security verification is passed according to the store information and the login account information, the store information is forwarded to the merchant management device corresponding to the device identifier to update a scan code state;
receiving a binding confirmation instruction, and sending a binding confirmation request, so that the merchant management device, in response to determining that the store information is successfully bound with device information of the merchant management device, displays the system desktop.

27. A non-transitory readable storage medium, having computer readable instructions stored thereon, wherein the computer readable instructions are executed by a processor to implement a security processing method for use of a merchant management device, which comprises:
before entering a system desktop of the merchant management device, acquiring a device identifier of the merchant management device, and sending an identification code generation request carrying the device identifier;
receiving an identification code generated according to the device identifier and a polling unique identifier;
displaying the identification code;
receiving store information that is to be bound, and updating a scan code state according to the store information, wherein the store information is sent in response to that it is determined that security verification is passed according to the store information and login account information of a scan code client;
sending, based on the polling unique identifier, a request for polling whether the store information is successfully bound with device information of the merchant management device; and
in response to determining that the store information is successfully bound with the device information, displaying the system desktop.

28. A merchant management device, comprising: a non-transitory readable storage medium, a processor, and computer readable instructions stored on the non-transitory readable storage medium and runnable on the processor, wherein the computer readable instructions are executed by the processor to implement a security processing method for use of a merchant management device, which comprises:
before entering a system desktop of the merchant management device, acquiring a device identifier of the merchant management device, and sending an identification code generation request carrying the device identifier;
receiving an identification code generated according to the device identifier and a polling unique identifier; displaying the identification code;
receiving store information that is to be bound, and updating a scan code state according to the store information, wherein the store information is sent in response to that it is determined that security verification is passed according to the store information and login account information of a scan code client;
sending, based on the polling unique identifier, a request for polling whether the store information is successfully bound with device information of the merchant management device; and
in response to determining that the store information is successfully bound with the device information, displaying the system desktop.

29. A security processing system for use of a merchant management device, comprising: a server, a client device of claim 26, and a merchant management device of claim 28, wherein the server is configured to:
receive an identification code generation request sent by the merchant management device, the generation request carrying a device identifier of the merchant management device, and the generation request being sent before entering a system desktop of the merchant management device;
generate an identification code and a polling unique identifier according to the device identifier;
send the identification code and the polling unique identifier to the merchant management device, so that the merchant management device displays the identification code;
receive a notification request sent by the client device, the notification request carrying selected store information that is to be bound, login account information of the client device, and the device identifier of the merchant management device obtained by scanning the identification code;
in response to determining that security verification is passed according to the store information and the login account information, forward the store information to the merchant management device corresponding to the device identifier to update a scan code state;
receive a binding confirmation request sent by the client device to bind the store information with device information of the merchant management device, and
in response to receiving a request for polling a binding result sent by the merchant management device based on the polling unique identifier, feed back response information indicating that binding is successful, so that the merchant management device displays the system desktop.
